(19) United States
(12) Patent Application Publication
(10) Pub. No.: US 2017/0203337 A1
(43) Pub. Date: Jul. 20, 2017

(54) ANTI-SPLASH CLEANING MACHINE

(71) Applicant: YONGKANG XIEHENG ZHEJIANG PROVINCE INDUSTRY & COMMERCE CO., LTD, Yongkang (CN)

(72) Inventor: Xianghai LUO, Yongkang (CN)

(21) Appl. No.: 15/057,753

(22) Filed: Mar. 1, 2016

(30) Foreign Application Priority Data
Jan. 20, 2016 (CN) 201620056780.6

(51) Int. Cl. B08B 3/00; B08B 3/10; B08B 3/08; B08B 3/02; B08B 5/02

(52) U.S. Cl. CPC B08B 3/006; B08B 3/026; B08B 5/02; B08B 3/08; B08B 3/10

(57) ABSTRACT

An anti-splash cleaning machine is capable of providing a cleaning liquid with an impact pressure to the surface of a mechanical part, wherein a cleaning box body is equipped with a box cover and a cleaning space is provided to receive parts to be cleaned. The machine further comprises a cleaning liquid tank and a cleaning gun comprising a cleaning liquid inlet, a compressed air inlet, a cleaning gun body, a liquid suction pipe fitting for connecting the cleaning liquid tank to the cleaning liquid inlet of the cleaning gun, and a liquid discharge pipe fitting for connecting the cleaning liquid tank to the liquid outlet of the cleaning box body. The cleaning gun body is provided with an air flow channel, a liquid flow channel and a mixed flow channel and the air flow channel and the liquid flow channel converge into the mixed flow channel.

### CROSS-REFERENCE TO RELATED APPLICATION

This application claims priority to Chinese Patent Application Serial No. 201620056780.6, filed Jan. 20, 2016, entitled ANTI-SPLASH CLEANING MACHINE the entirety of which is incorporated herein by reference.

### STATEMENT REGARDING FEDERALLY SPONSORED RESEARCH OR DEVELOPMENT

n/a

### TECHNICAL FIELD

This application is directed to a cleaning machine, in particular to a cleaning machine for the surface of a mechanical part, for example, in the field of automobile maintenance.

### BACKGROUND

In daily production and life, especially in the field of automobile maintenance, it is generally required to perform cleaning and maintenance for non-massive mechanical parts. In response to this demand, there are a variety of different types of professional cleaning equipment.

For commercially available common cleaning equipment, the cleaning liquid is supplied by a conventional electric water pump or pneumatic water pump, and the cleaning solution has no impact pressure.

### SUMMARY

The objective of the present disclosure is to provide an anti-splash cleaning machine capable of providing a cleaning liquid with an impact pressure to the surface of a mechanical part.

An embodiment of the present disclosure provides a heating-type cleaning machine, comprising a machine frame, a cleaning box body mounted on the machine frame, a cleaning liquid tank, a cleaning gun, a liquid suction pipe fitting, and a liquid discharge pipe fitting mounted on the machine frame. The cleaning box body is mounted on the machine frame and is equipped with a box cover which can be opened, provides a cleaning space for receiving the parts to be cleaned, and has a liquid outlet and a filter screen arranged on the liquid outlet, so as to discharge the cleaning liquid after filtered with the filter screen. The cleaning liquid tank mounted on the machine frame is used to store the cleaning liquid, with the periphery of said cleaning liquid tank being enclosed by protective plates. The top thereof being covered by said cleaning box body, and the bottom thereof being mounted on a guide rail. An electric heating element is arranged in the cleaning liquid tank. The cleaning gun comprises a cleaning liquid inlet, a compressed air inlet and a cleaning gun body. The interior of the cleaning gun body is provided with an air flow channel, a liquid flow channel, and a mixed flow channel. The air flow channel and the liquid flow channel converge into the mixed flow channel so that compressed air enters through the air flow channel. The cleaning liquid is ejected into the fluid flow channel, and then they are sprayed together out of the mixed flow channel. The liquid suction pipe fitting is connected to the cleaning liquid tank and the cleaning liquid inlet of the cleaning gun. The liquid discharge pipe fitting is connected to the cleaning liquid tank and the liquid outlet of the cleaning box body.

In an embodiment of the present disclosure, the front side of said cleaning liquid tank is locked to said machine frame by a locking member. Said locking member is shielded by a front protective plate at the front side of said cleaning liquid tank. Said front protective plate is arranged to be a structure which can be flipped on said machine frame so as to expose said locking member in an open state.

In an embodiment of the present disclosure, said front protective plate is at least partially arranged to be a control panel. Said control panel comprises a human-computer interaction interface and a control module coupled to the back side of said human-computer interaction interface. An outer side of said cleaning liquid tank is connected to a temperature control module and said control module is connected to said temperature control module through a cable.

In an embodiment of the present disclosure, the bottom of said front protective plate is connected to said machine frame through a hinge. The bottom of said front protective plate abuts against said machine frame when said front protective plate is in the open state to limit the open angle of said front protective plate.

In an embodiment of the present disclosure, the top of said front protective plate is fastened to said machine frame by means of a spring snap-fitting assembly. Said spring snap-fitting assembly comprises an elastic plug capable of being pressed inwardly for elastic deformation and a spring socket having a gap. The thickness of said elastic plug being greater than the width of the gap of said spring socket and said elastic plug being inserted in said spring socket.

In an embodiment of the present disclosure, the left and right side walls of said cleaning box body are respectively connected to the left and right side walls of said box cover to form a connecting rod mechanism. Said connecting rod mechanism comprises said cleaning box body, said box cover, a first connecting rod respectively hinged to the side wall of said cleaning box body and the side wall of said box cover, and a second connecting rod respectively hinged to the side wall of said cleaning box body, and the side wall of said box cover. The moving path of said box cover from a closed state of said box cover to an open state of said box cover is defined by said connecting rod mechanism as downward movement at the front side and upward movement at the rear side. At said open position, said connecting rod mechanism has passed the dead point and is locked by the weight of said box cover.

In an embodiment of the present disclosure, the front side of said box cover facing an operation station has a middle part and inclined surfaces inclined from said middle part to the two sides. Each of said inclined surfaces is provided with an opening and a protective glove arranged at the inner side of the opening. The bottom sides of said inclined surfaces are inclined to the bottom side of said middle part. The bottom sides of said inclined surfaces and the bottom sides of said middle part form a continuous collecting trough and the bottom side of said middle part is further provided with a water outlet.

In an embodiment of the present disclosure, said cleaning gun body is provided with a switch for controlling a switch valve in said liquid flow channel to switch between the connection and disconnection states of said fluid channel, so as to switch to a cleaning mode or a blow-drying mode of said cleaning gun body.

In an embodiment of the present disclosure, a liquid suction port of said liquid suction pipe fitting is connected to the top of said cleaning liquid tank.

In an embodiment of the present disclosure, said machine frame is provided at the left and right sides of said cleaning liquid tank with a respective raised mounting positioning member for defining the position of said cleaning liquid tank.

In an embodiment of the present disclosure, the periphery of said cleaning liquid tank is enclosed by protective plates. The top thereof is covered by said cleaning box body and the bottom thereof is mounted on a guide rail. The cleaning liquid tank is provided in the interior with an electric heating element. The front side of said cleaning liquid tank is locked to said machine frame by a locking member. Said locking member is shielded by a front protective plate at the front side of said cleaning liquid tank and said front protective plate is arranged to be a structure which can be flipped on said machine frame so as to expose said locking member in the open state. Said front protective plate is at least partially arranged to be a control panel. Said control panel comprises a human-computer interaction interface and a control module coupled to the back side of said human-computer interaction interface. An outer side of said cleaning liquid tank is connected to a temperature control module and said control module is connected to said temperature control module through a cable.

In an embodiment of the present disclosure, the bottom of said front protective plate is connected to said machine frame through a hinge. The bottom of said front protective plate abuts against said machine frame when said front protective plate is in the open state to limit the open angle of said front protective plate.

In an embodiment of the present disclosure, the top of said front protective plate is fastened to said machine frame by means of a spring snap-fitting assembly. Said spring snap-fitting assembly comprises an elastic plug capable of being pressed inwardly for elastic deformation and a spring socket having a gap, the thickness of said elastic plug being greater than the width of the gap of said spring socket, and said elastic plug being inserted in said spring socket.

The beneficial effects of the present disclosure embodiment are as follows:

the cleaning liquid is introduced at different pressures of compressed air, so as to adapt to the cleaning of parts of different materials in the range of various machine setting parameters (volume, weight); the beneficial effects further include, but are not limited to:

1. using a high-speed washing liquid flow with impact to quickly remove stains and oils on the surface of the mechanical parts to achieve the purpose of cleaning;

2. suitable for various neutral water-based or oil-based cleaning liquids;

3. using a small amount of cleaning liquid in cycle to achieve the effect of energy-saving cleaning;

4. ensuring no contamination or splash of the cleaning liquid around the cleaning environment, while ensuring high-speed washing;

5. providing a labor-saving and convenient operations to achieve efficient cleaning; and

6. being capable of adjustment and control according to different cleaning liquid temperatures required in different environments to achieve the optimal cleaning effect.

### BRIEF DESCRIPTION OF THE DRAWINGS

The above-mentioned and other features, properties and advantages of the present disclosure will become more apparent from the following description of embodiments with reference to the accompany drawings, in which:

FIG. 1 is an exploded view of the anti-splash cleaning machine in the first embodiment of the present disclosure;

FIG. 2 is a three-dimensional diagram of the anti-splash cleaning machine in the first embodiment of the present disclosure;

FIG. 3 is a three-dimensional diagram of the anti-splash cleaning machine in the first embodiment of the present disclosure in an open state;

FIG. 4 is a schematic diagram of the anti-splash cleaning machine in the first embodiment of the present disclosure, with the shelf removed;

FIG. 5 is another three-dimensional diagram of the anti-splash cleaning machine in the first embodiment of the present disclosure in the open state;

FIG. 6 is a side view of the anti-splash cleaning machine in the first embodiment of the present disclosure in the open state;

FIG. 7 is a schematic diagram of the operating principle of the cleaning gun in the first embodiment of the present disclosure;

FIG. 8 is another three-dimensional diagram of the anti-splash cleaning machine in the first embodiment of the present disclosure in the open state;

FIG. 9 is another three-dimensional diagram of the anti-splash cleaning machine in the first embodiment of the present disclosure in the open state;

FIG. 10 is another three-dimensional diagram of the anti-splash cleaning machine in the first embodiment of the present disclosure in the open state, with the portion of the cleaning box body omitted;

FIG. 11 is an exploded view of the heating-type cleaning machine in the second embodiment of the present disclosure;

FIG. 12 is a schematic diagram of the heating-type cleaning machine in the second embodiment of the present disclosure, with the cleaning liquid tank pulled out;

FIG. 13 is a schematic diagram of the cleaning liquid tank of the heating-type cleaning machine in the second embodiment of the present disclosure, with the front side protective plate opened;

FIG. 14 is a schematic diagram only showing the machine frame and the cleaning liquid tank in the second embodiment of the present disclosure;

FIG. 15 is another schematic diagram of the cleaning liquid tank of the heating-type cleaning machine in the second embodiment of the present disclosure, with the front side protective plate opened;

FIG. 16 is a partially enlarged schematic front view of the cleaning liquid tank of the heating-type cleaning machine in the second embodiment of the present disclosure, with the front side protective plate opened; and

FIG. 17 is a schematic diagram only showing the machine frame and the cleaning liquid tank in the second embodiment of the present disclosure.

### DETAILED DESCRIPTION

The present disclosure will be further described below in conjunction with particular embodiments and the accompanying drawings and more details are explained in the following description. In order to fully understand the present disclosure, however, the present disclosure can obviously be implemented differently from what is described herein. A person skilled in the art can make similar extensions and deductions without departing from the connotation of the disclosure according to practical applications. Therefore, the scope of protection of the present disclosure should not be limited to the contents of the particular embodiments herein.

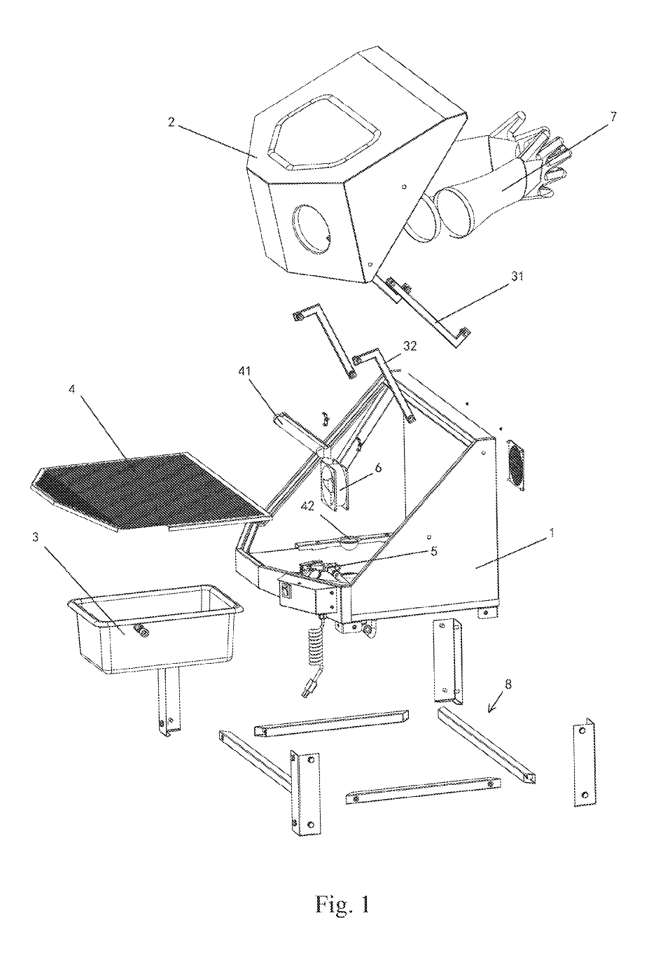

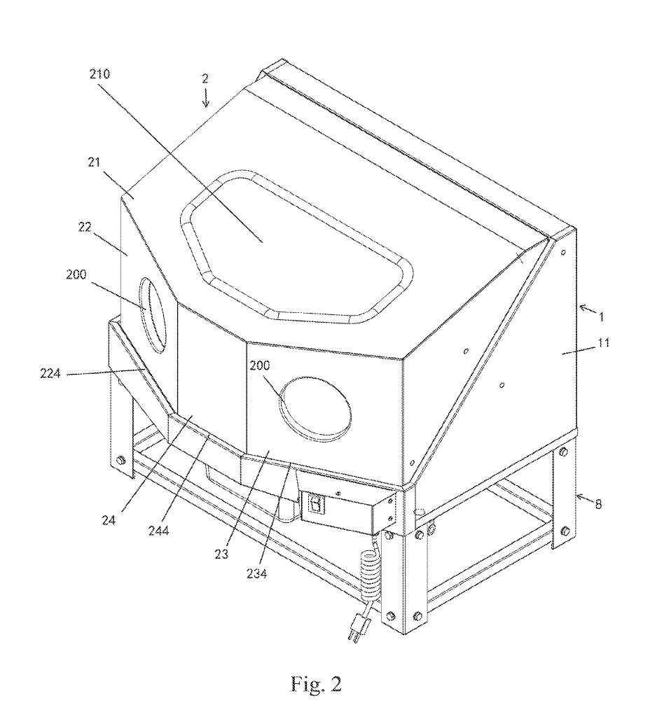

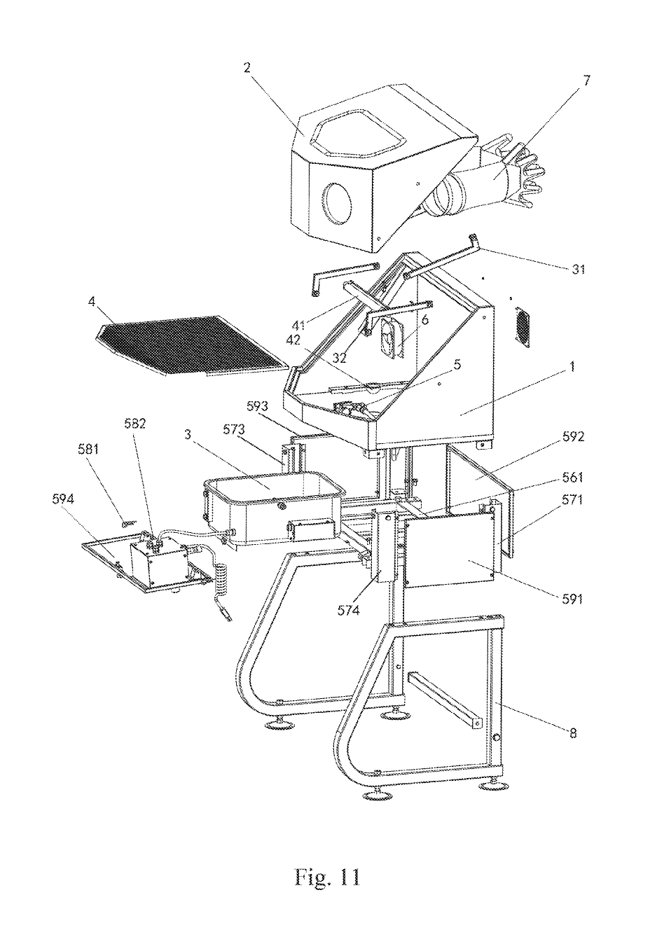

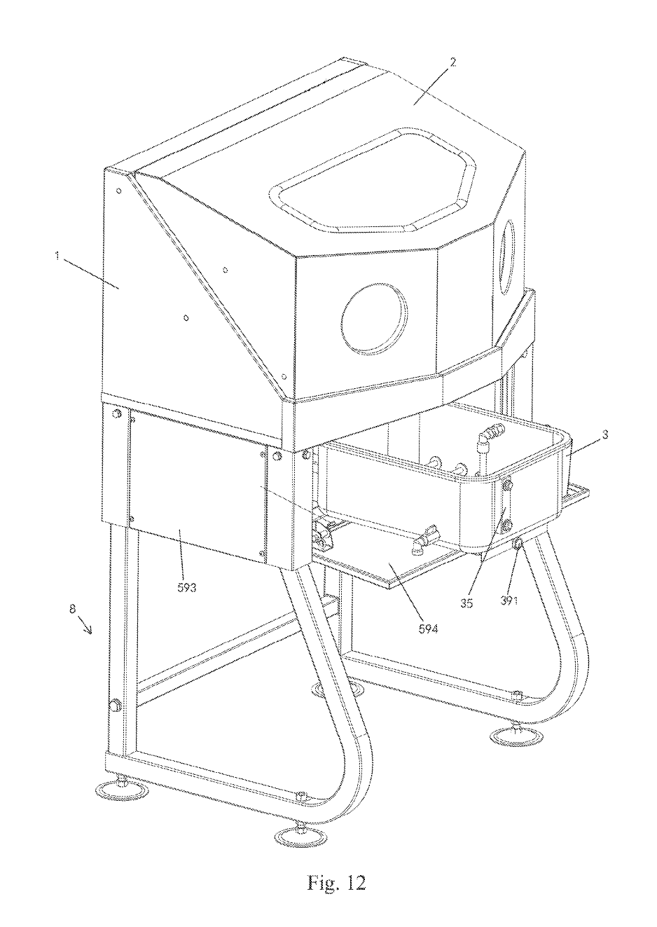

FIGS. 1-10 show the first embodiment of the present disclosure, and FIGS. 11-17 show the second embodiment of the present disclosure. It should be noted that the drawings are merely used as examples, are not necessarily drawn to scale, and should not be taken as a limitation to the actually claimed scope of protection of the present disclosure.

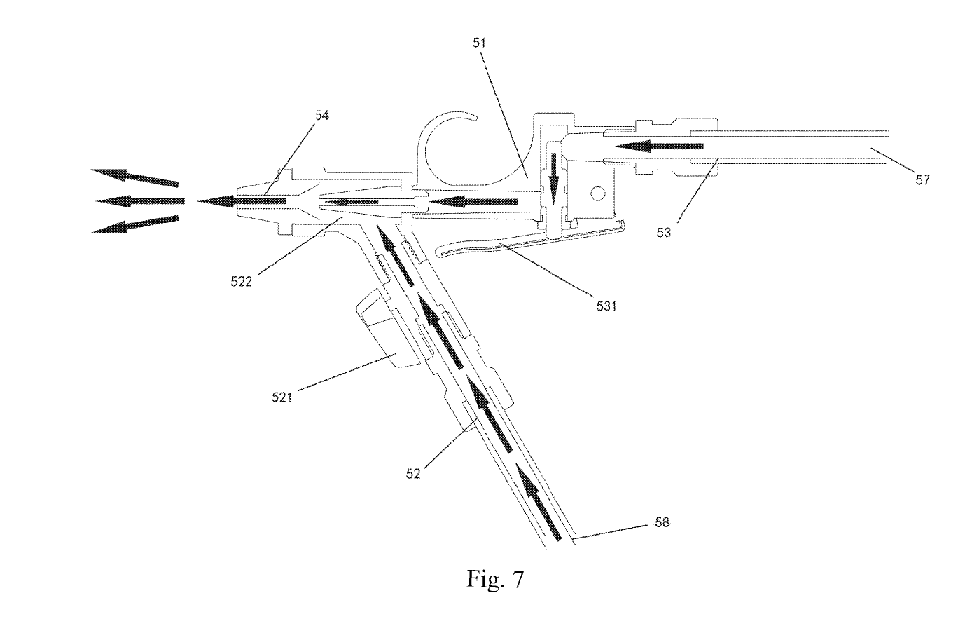

As shown in FIGS. 1-4, the anti-splash cleaning machine comprises a machine frame 8, a cleaning box body 1, a box cover 2, a cleaning liquid tank 3, and a cleaning gun 5. The cleaning box body 1 is mounted on the machine frame 8 and the box cover 2 is arranged on the cleaning box body 1 and can be opened and closed. The cleaning box body 1 provides a cleaning space for receiving the parts to be cleaned, e.g., automobile parts, has a liquid outlet 15, and is further provided at the liquid outlet 15 with a filter screen 42 so that the cleaning liquid is discharged from the liquid outlet 15 to the cleaning liquid tank 3 through the filter screen 42. The cleaning liquid tank 3 is also mounted on the machine frame 8 and is located below the cleaning box body 1. The cleaning liquid can be directly discharged from the liquid outlet 15 to the cleaning liquid tank 3. The cleaning liquid in the cleaning liquid tank 3 serves as a liquid supply source for the cleaning gun 5. The cleaning gun 5, as shown in FIG. 7, comprises a cleaning gun body 51, a cleaning liquid inlet 58 and a compressed air inlet 57. The cleaning liquid inlet 58 of the cleaning gun body 51 is connected to the liquid suction pipe fitting 55 and the compressed air inlet 57 is connected to an air inlet pipe fitting 56. The other end of the liquid suction pipe fitting 55 is connected to the cleaning liquid tank 3 while the other end of the air inlet pipe fitting 56 is connected to a compressed air source, e.g., an air pump.

The working region of the anti-splash cleaning machine adopts a structure of a closed operating space to prevent splash of the high-speed cleaning liquid so as to provide a clean working environment with low contamination, while strengthening the protection for the operator to completely prevent the cleaning liquid from splashing into the eyes, nose, and mouth of the operator.

As shown in FIG. 7, the cleaning gun body 51 is provided in the interior with an air flow channel 53, a liquid flow channel 52 and a mixed flow channel 54. The air flow channel 53 and the liquid flow channel 52 converge into the mixed flow channel 54 to function as a negative pressure cavity at the tail end 522 of the liquid flow channel 52. The compressed air flowing at a high speed enters through the air flow channel 53 to form a negative pressure at the tail end 522 of the liquid flow channel 52 so that the cleaning liquid is sucked up to enter through the liquid flow channel 52 and sprayed together with the compressed air in the mixed flow channel 54, out of the cleaning gun body 51. An air inlet switch 531 can be arranged in the air flow channel 53, and the air inlet switch 531 is opened so as to introduce the compressed air. A switch 521 can be arranged in the liquid flow channel 52, and the switch 521 is used to control the connection and disconnection of the liquid flow channel 52. If the operator controls the switch 521 to disconnect the liquid flow channel 52, the product is blow-dried, and if the operator controls the switch 521 to connect the liquid flow channel 52, the product is cleaned. Therefore, the switch 521 can be used to switch between the operating modes of the cleaning gun 5. The cleaning gun 5 is mainly used in the fields of automobile maintenance and cleaning for non-massive mechanical parts. In a normal power supply and air supply environment, it can expediently provide cleaning liquid flow having an impact of 60-120 PSI for cleaning the parts conveniently and rapidly. In addition, a pressure adjusting device can be equipped according to the customers' requirements to use cleaning liquid flow of different pressures as desired.

A shelf 4 is arranged in the cleaning box body 1 and covers substantially the whole inner bottom face of the cleaning box body 1. The shelf 4 can be used to filter the cleaning liquid so that the cleaning liquid is subjected to rough filtration on the shelf 4 in advance and then is re-filtered at the filter screen 42. The shelf 4 can be removed separately for cleaning.

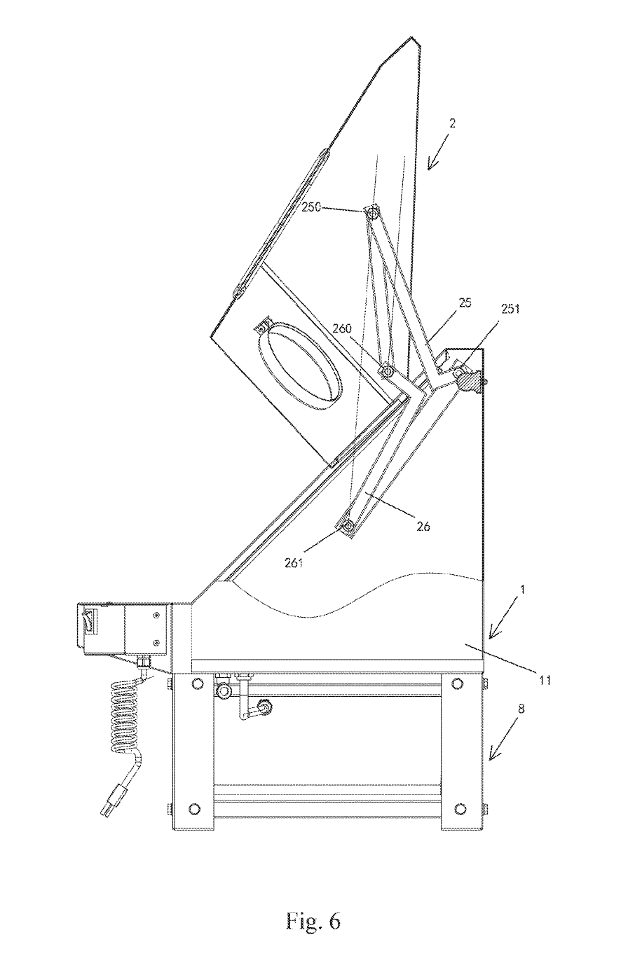

As shown in FIGS. 1-6, the left and right side walls 12, 11 of the cleaning box body 1 are respectively connected to the left and right side walls 252, 251 of box cover 2 to form a connecting rod mechanism. Since the cases at the left and right sides are substantially the same, only the case shown in FIG. 6 will be described. As shown in FIG. 6, the portions of side walls 11, 251 are not shown in FIG. 6 for facilitating observation of the structure therein. The connecting rod mechanism comprises a tank body 1, a box cover 2, a first connecting rod 25 respectively hinged to the side wall 11 of the tank body 1 and the side wall 251 of the box cover 2 and a second connecting rod 26 respectively hinged to the side wall 11 of the tank body 1 and the side wall 251 of the box cover 2. The tank body 1 is equivalent to the machine frame of the connecting rod mechanism. The box cover 2, the first connecting rod 25, and the second connecting rod 26 are movable parts. The box cover 2 is a driving member and the rest are driven members. The moving path of the box cover 2 is arranged such that, from the closed state of the box cover 2 to the open state of the box cover 2, the front side of the box cover 2 moves downwards while the rear side moving upwards. Moreover, at the open position the connecting rod mechanism has passed the dead point and is locked by the weight of the box cover 2. Since the box cover 2 has passed the dead point it will not drop automatically. When the box cover 2 is closed, lifting the rear part of the box cover 2 allows the connecting rod mechanism to move in the opposite direction so as to close the tank body 1.

As shown in FIGS. 1, 2 and 5, the front side of the box cover 1 facing the operation station has a middle part 24 and two inclined surfaces 22, 23 inclined from the middle part 24 to the two sides. Each of the inclined surfaces 22, 23 is provided with an opening 200 and a protective glove 7 arranged at the inner side of the opening 200. The bottom sides 224, 234 of the inclined surfaces 22, 23 are inclined to the bottom side 244 of the middle part 24. The bottom sides 224, 234 of the inclined surfaces 22, 23 and the bottom side 244 of the middle part 24 form a continuous collecting trough so that the water falling from the above is collected to the bottom side of the middle part. The bottom side 244 of the middle part 24 further provides a water outlet 234 so that the collected cleaning liquid is exclusively discharged from the water outlet to prevent the accumulated cleaning liquid from overflowing without restraint by accurately flowing from the water outlet 234 to the tank body 1, so as to avoid the contamination of the cleaning liquid to the outside. The two inclined surfaces 22, 23 match with ergonomic structures which can create a comfortable operating environment. The middle part 24 is planar, providing a place at which the operator can lean on the box cover to operate. The protective gloves 7 can effectively protect the hands of the operator to avoid the direct contact with the cleaning liquid while avoiding damage to the personnel caused by the impurities in the high-speed cleaning liquid flow.

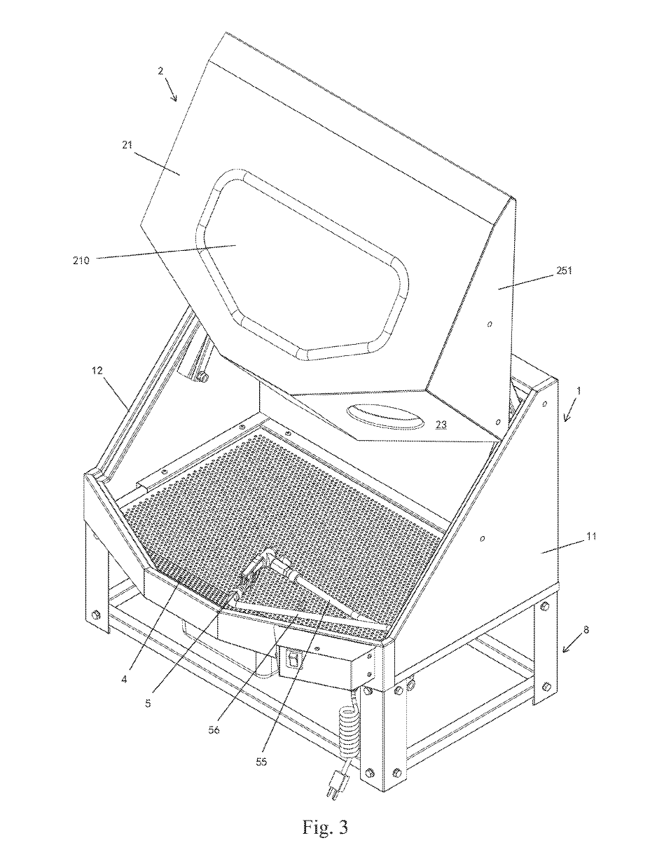

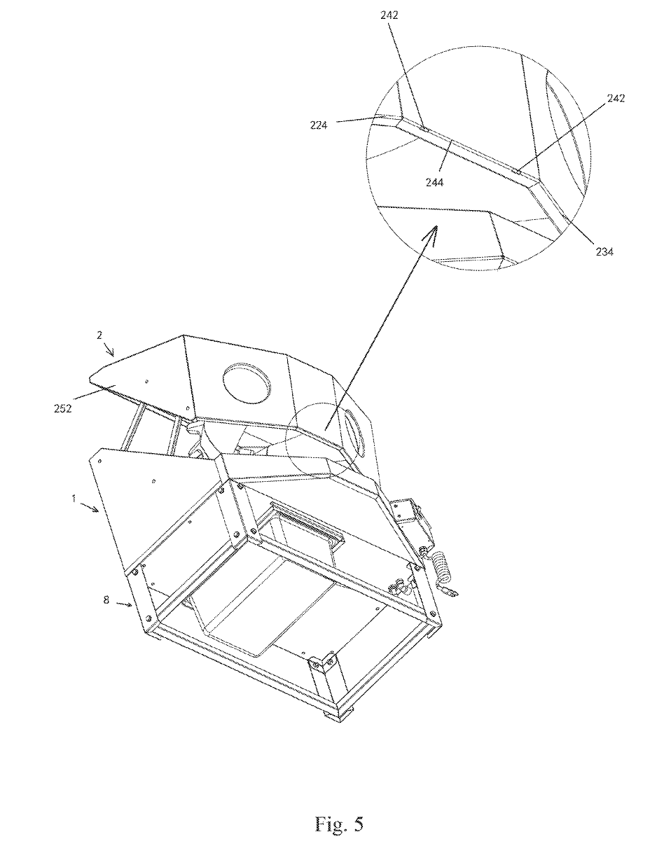

As shown in FIGS. 3 and 5, the edges of the left and right sides 251, 252 of the box cover 2 and the edges of the left and right sides 11, 12 of the tank body 1 which match with each other are inclined toward the bottom side of the tank body 1 to enlarge the inlet of the tank body 1 so as to ensure that the parts to be cleaned can be conveniently and rapidly put in and out.

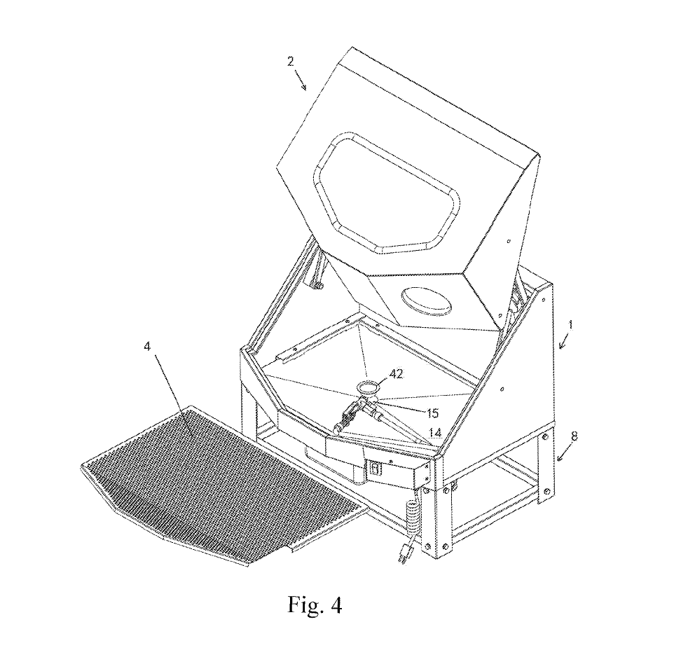

As shown in FIG. 4, the periphery of the bottom 14 of the tank body 1 is inclined to the middle part. The liquid outlet 15 is arranged at the middle part of the bottom 14 so as to facilitate rapid flow-back of the cleaning liquid to the cleaning liquid tank.

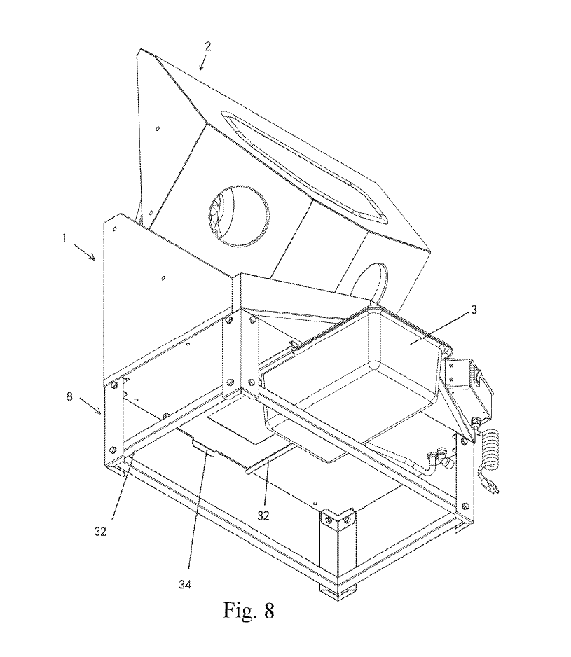

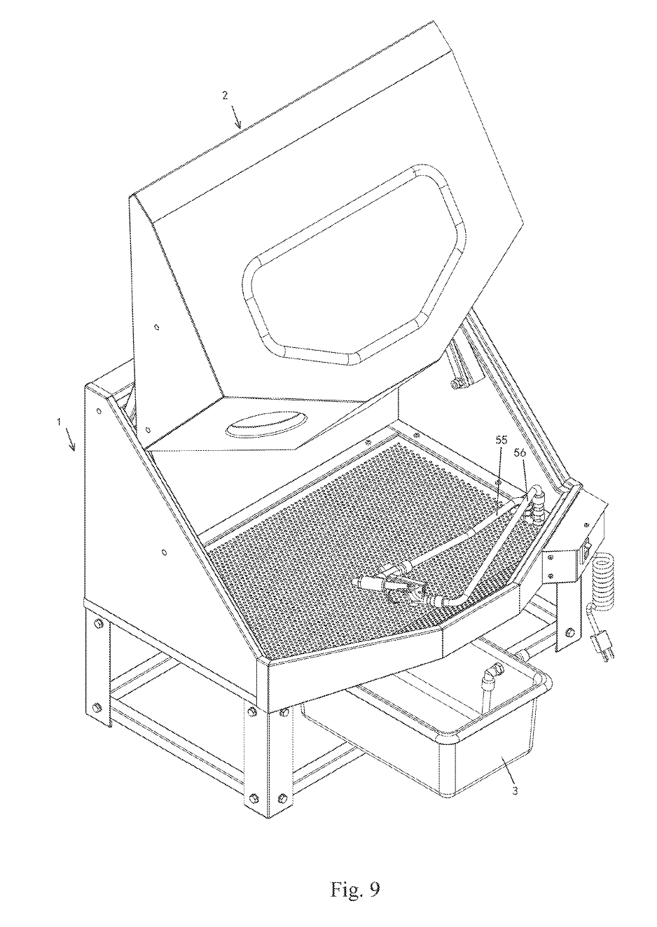

As shown in FIGS. 8 and 9, the cleaning liquid tank 3 is arranged below the bottom of the cleaning box body 1 and is mounted on the machine frame 8 by means of a sliding rail 32. The machine frame 8 is further provided with a limiting device 34. The limiting device 34 defines the mounted position of the cleaning liquid tank 3.

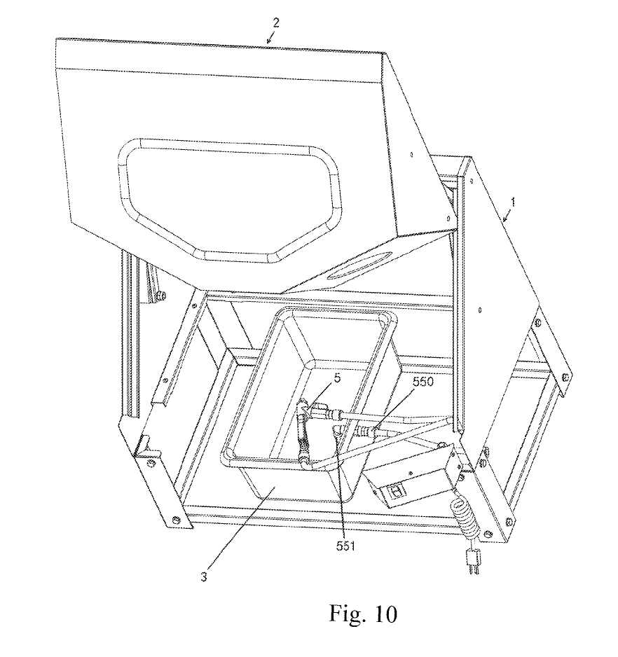

As shown in FIG. 10, the liquid suction port 550 of the liquid suction pipe fitting 55 is connected to the top of the cleaning liquid tank 3 so as to effectively avoid the contamination of the external environment during disassembly due to excessive residual cleaning liquid in the liquid suction pipe. The liquid suction port 550 can adopt a quick release port and the interior of the cleaning liquid tank 3 is connected to the liquid suction port 550 through the quick release port via the liquid suction pipe 551.

FIGS. 11-17 show the second embodiment of the present disclosure. This embodiment uses the reference numbers of elements and parts of the contents in the preceding embodiments wherein the same reference numbers are used to denote the same or similar elements, and the description of the same technical content is selectively omitted. With regard to the description of the omitted part, reference can be made to the preceding embodiment, and no redundant description will be provided in the present embodiment.

As shown in FIGS. 11-17, different from the embodiments shown in FIGS. 1-16, a heating element 371 is arranged in the cleaning liquid tank 3. The periphery of the cleaning liquid tank 3 is enclosed by protective plates 591, 592, 593, 594. Accordingly, the heating element 371 is controlled by a temperature control module 37 and the temperature control module 37 is in turn driven by a control module 38. The protective plates 591, 592, 593, 594 are connected respectively by columns 571, 572, 573, 574.

The front side of the cleaning liquid tank 3 is locked to the machine frame 8 by a locking member 391. The locking member 391 is shielded by the front protective plate 594 at the front side of the cleaning liquid tank 3 and the front protective plate 594 is arranged on the machine frame 8 to be a structure which can be flipped to expose the locking member 391 in the open state. In a state that the locking member 391 is not opened, the cleaning liquid tank 3 is firmly fixed to the machine frame 8, and only in the case that the front protective plate 594 is shielded, the locking member 391 can be opened. The locking member 391 may be a bolt. A liquid level meter 35 is further provided at the front side of the cleaning liquid tank 3 and the liquid level meter 35 is used to observe the liquid level of the cleaning liquid tank 3. Opening the front protective plate 594 also facilitates observation of the liquid level meter 35.

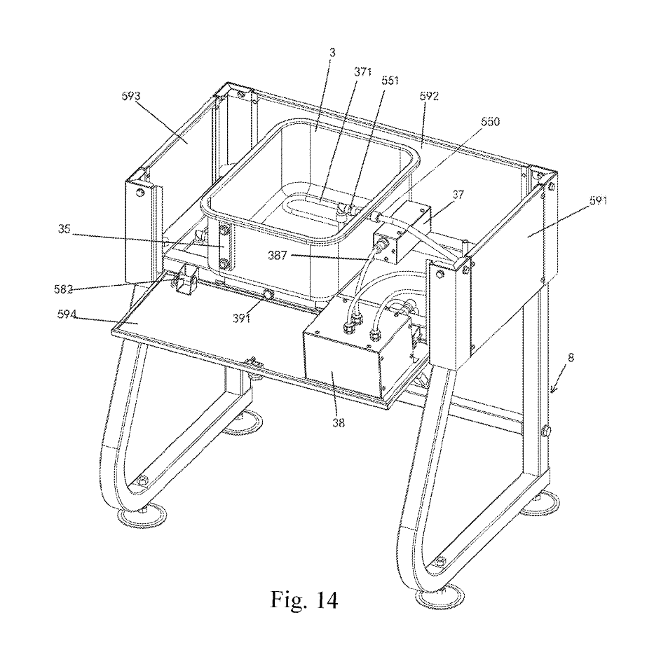

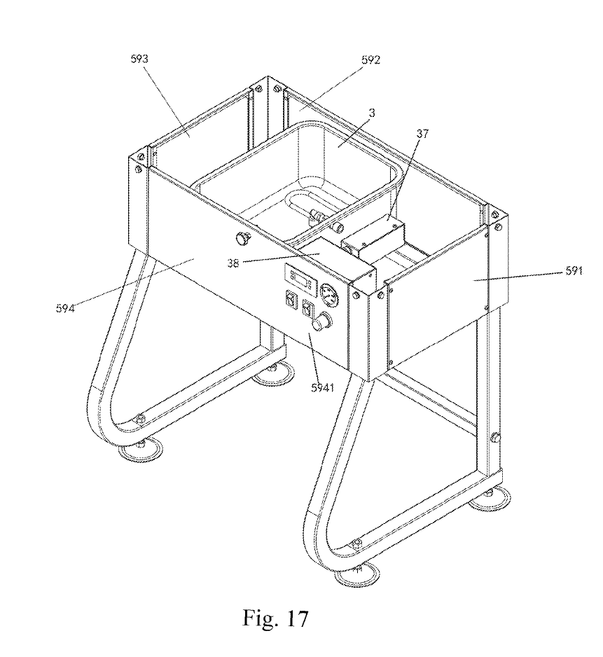

As shown in FIG. 17, the front protective plate 594 is at least partially arranged to be a control panel 5941. The control panel 5941 comprises a human-computer interaction interface and a control module 38 coupled to the back side of the human-computer interaction interface. As shown in FIG. 14, an outer side of the cleaning liquid tank 3 is connected to a temperature control module 37 and the control module 38 is connected to the temperature control module 37 through a cable 387. The human-computer interaction interface can be a knob, a button, a display screen and/or an indicating instrument. The control module 38 comprises a circuit board and a shell covering the circuit board. The control module 38 is sealed and waterproofed owing to the arrangement of the shell. Likewise, the temperature control module 37 comprises an electrical controller and a shell and is covered by the shell to form a functional module which is sealed and waterproofed. The temperature control module 37 receives an instruction sent by the control module 38 to drive the operation of the heating element 371. The temperature control module 37 can set various parameters, e.g., the heating temperature applied by the heating element, by means of the human-computer interaction interface thereon.

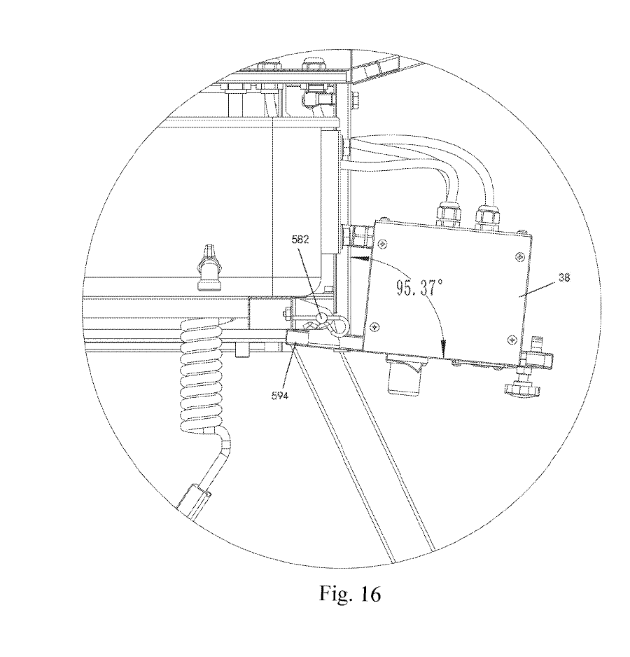

As shown in FIGS. 14, 15 and 16, the bottom of the front protective plate 594 is connected to the machine frame 8 through the hinge 582. The hinge 582 can be equipped with a hinge limiting latch 581. The bottom of the front protective plate 594 abuts against the machine frame 8 in the state that the front protective plate 594 is opened, so as to limit the open angle of the front protective plate 594. As shown in FIG. 16, the angle is limited thereby is 95.37°. The open degree of the front protective plate 594 can be set according to the specific requirements of customers.

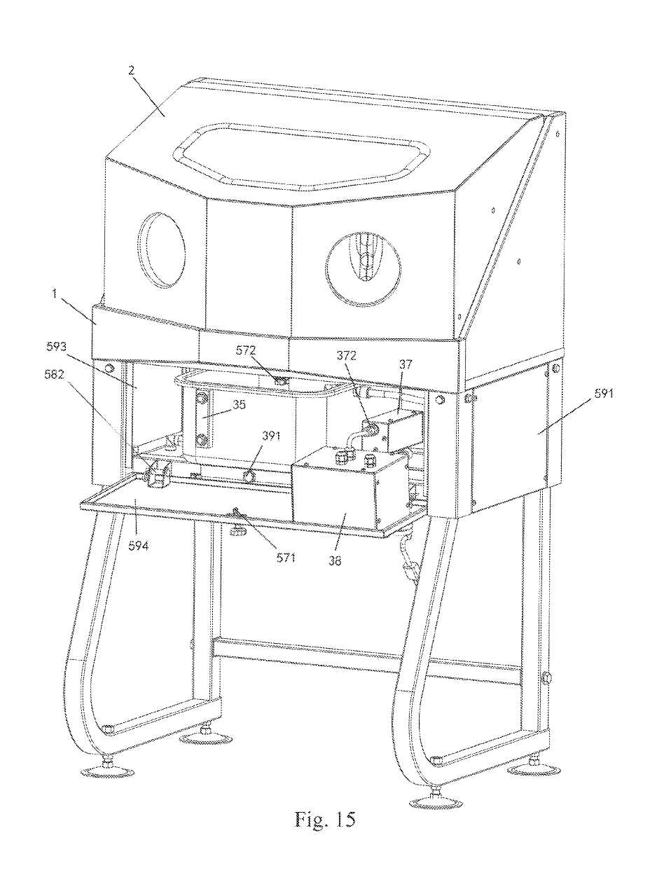

As shown in FIG. 15, the top of the front protective plate 594 is fastened to the machine frame 8 through a spring snap-fitting assembly. The spring snap-fitting assembly comprises an elastic plug 571 capable of being pressed inwardly for elastic deformation and a spring socket 572 having a gap, the thickness of the elastic plug 571 being greater than the width of the gap of the spring socket 572, and the elastic plug 571 being inserted in the spring socket 572 so that this structure can allow the front protective plate 594 to be rapidly and securely fixed to the machine frame 8.

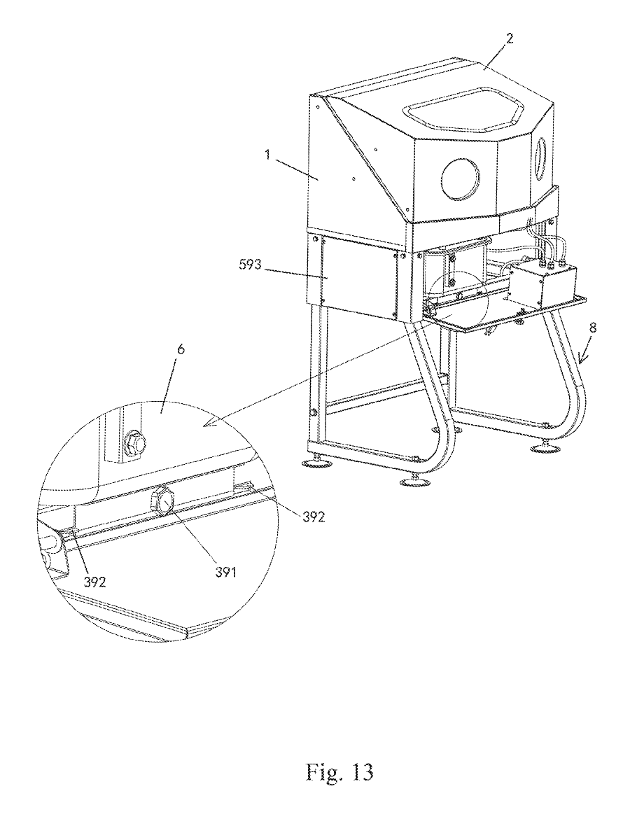

As shown in FIG. 13, the machine frame 8 is provided at the left and right sides of the cleaning liquid tank 3 with a respective raised mounting positioning member 392 for defining the position of the cleaning liquid tank 3. In addition to positioning, the mounting positioning member 392 can also serve the purpose of guidance during the assembly of the cleaning liquid tank 3.

The present disclosure has been disclosed above by way of preferred embodiments, which, however, are not intended to limit the present disclosure. Any person skilled in the art could make possible changes and alterations without departing from the spirit and scope of the present disclosure. For example, a defogging fan 6, an LED lamp 41, etc., can be arranged in the cleaning box body 5. Hence, any alteration, equivalent change and modification which are made to the above-mentioned embodiments in accordance with the technical substance of the present disclosure and without departing from the contents of the present disclosure will fall within the scope of protection defined by the claims of the present disclosure.

What is claimed is:

1. An anti-splash cleaning machine, characterized by comprising:
a machine frame;
a cleaning box body, which is mounted on the machine frame, the cleaning box body being equipped with a box cover which can be opened, providing a cleaning space for receiving the parts to be cleaned, and has a liquid outlet and a filter screen arranged on the liquid outlet, so as to discharge the cleaning liquid after being filtered by the filter screen;
a cleaning liquid tank mounted on the machine frame for storing the cleaning liquid;
a cleaning gun with a cleaning liquid inlet, a compressed air inlet and a cleaning gun body;
a liquid suction pipe fitting for connecting the cleaning liquid tank to the cleaning liquid inlet of the cleaning gun; and
a liquid discharge pipe fitting for connecting the cleaning liquid tank to the liquid outlet of the cleaning box body;
wherein the interior of the cleaning gun body is provided with an air flow channel, a liquid flow channel and a mixed flow channel, and the air flow channel and the liquid flow channel converge into the mixed flow channel, so that a compressed air enters through the air flow channel, the cleaning liquid is ejected into the fluid flow channel, and then the air and the liquid are sprayed together out of the mixed flow channel.

2. The anti-splash cleaning machine as claimed in claim 1, wherein the left and right side walls of the cleaning box body are respectively connected to the left and right side walls of the box cover to form a connecting rod mechanism;
the connecting rod mechanism comprises the cleaning box body, the box cover, a first connecting rod respectively hinged to the side wall of the cleaning box body and the side wall of the box cover, and a second connecting rod respectively hinged to the side wall of the cleaning box body and the side wall of the box cover;
the moving path of the box cover from a closed state of the box cover to an open state of the box cover is defined by the connecting rod mechanism as downward movement at the front side and upward movement at the rear side; and
at the open position, the connecting rod mechanism has passed the dead point and is locked by the weight of the box cover.

3. The anti-splash cleaning machine as claimed in claim 2, wherein the front side of the box cover facing an operation station has a middle part and inclined surfaces inclined from the middle part to two sides, each of the inclined surfaces is provided with an opening and a protective glove arranged at the inner side of the opening, the bottom sides of the inclined surfaces are inclined to the bottom side of the middle part, the bottom sides of the inclined surfaces and the bottom sides of the middle part form a continuous collecting trough, the bottom side of the middle part is further provided with a water outlet, and the water outlet is always at the lowermost point of the collecting trough of the box cover during the opening of the box cover, the vertical projection position thereof is in the interior of the cleaning box body.

4. The anti-splash cleaning machine as claimed in claim 1, wherein the cleaning gun body is provided with a switch for controlling a switch valve in the liquid flow channel to switch between the connection and disconnection states of the fluid channel, so as to switch to a cleaning mode or a blow-drying mode of the cleaning gun body.

5. The anti-splash cleaning machine as claimed in claim 3, wherein the top side of the box cover is inclined toward the front side and is provided with an observation panel.

6. The anti-splash cleaning machine as claimed in claim 3, wherein the edges of the left and right sides of the box cover and edges of the left and right sides of the cleaning box body which are matched with each other are inclined toward the bottom side of the cleaning box body to enlarge the inlet of the cleaning box body.

7. The anti-splash cleaning machine as claimed in claim 3, wherein the periphery of the bottom of the cleaning box body is inclined to the middle part, and the liquid outlet is arranged in the middle part.

8. The anti-splash cleaning machine as claimed in claim 1, wherein the cleaning liquid tank is arranged below the bottom of the cleaning box body, and is mounted on the machine frame by means of a sliding rail, and the tail end of the sliding rail is provided with a limiting device which defines the mounted position of the cleaning liquid tank.

9. The anti-splash cleaning machine as claimed in claim 1, wherein a liquid suction port of the liquid suction pipe fitting is connected to the top of the cleaning liquid tank.

10. The anti-splash cleaning machine as claimed in claim 1, wherein the cleaning box body is provided in the interior thereof with a meshed shelf which covers the whole bottom of the cleaning box body, and the shelf can filter the cleaning liquid before the filter screen.

11. The anti-splash cleaning machine as claimed in claim 1, wherein the periphery of the cleaning liquid tank is enclosed by protective plates, the top thereof is covered by the cleaning box body, and the bottom thereof is mounted on a guide rail;
the cleaning liquid tank is provided in the interior thereof with an electric heating element;
the front side of the cleaning liquid tank is locked to the machine frame by a locking member, the locking member is shielded by a front protective plate at the front side of the cleaning liquid tank, and the front protective plate is arranged to be a structure which can be flipped on the machine frame so as to expose the locking member in an open state;
the front protective plate is at least partially arranged to be a control panel, the control panel comprises a human-computer interaction interface and a control module coupled to the back side of the human-computer interaction interface; and
an outer side of the cleaning liquid tank is connected to a temperature control module, and the control module is connected to the temperature control module through a cable.

12. The anti-splash cleaning machine as claimed in claim 11, wherein the bottom of the front protective plate is connected to the machine frame through a hinge, and the bottom of the front protective plate abuts against the machine frame when the front protective plate is in the open state to limit the open angle of the front protective plate.

13. The anti-splash cleaning machine as claimed in claim 11, wherein the top of the front protective plate is fastened to the machine frame by means of a spring snap-fitting assembly, the spring snap-fitting assembly comprises an elastic plug capable of being pressed inwardly for elastic deformation and a spring socket having a gap, the thickness of the elastic plug being greater than the width of the gap of the spring socket, and the elastic plug being inserted in the spring socket.
